(19) United States
(12) Patent Application Publication
(10) Pub. No.: US 2012/0317995 A1
(43) Pub. Date: Dec. 20, 2012

(54) PUMP FOR CONVEYING A CRYOGENIC FLUID

(75) Inventors: Klaus BRUNNHOFER, Graz (AT); Walter PESCHKA, Boblingen (DE)

(73) Assignee: MAGNA STEYR Fahrzeugtechnik AG & Co KG, Graz (AT)

(21) Appl. No.: 13/525,629

(22) Filed: Jun. 18, 2012

(30) Foreign Application Priority Data
Jun. 18, 2011 (DE) 10 2011 104 546.9

(51) Int. Cl. F04B 19/24; F04B 19/20; F17C 7/00

(52) U.S. Cl. 62/45.1; 417/207

(57) ABSTRACT

A pump for conveying a cryogenic fluid from a tank into a container which is under a higher pressure. The pump includes a cylinder having a piston which defines a low-temperature chamber and a high-temperature chamber in the cylinder such that during a first stroke movement of the piston, the volume of the low-temperature chamber decreases and the volume of the high-temperature chamber increases correspondingly, and during a second stroke movement of the piston which runs in the opposite direction of the first stroke movement, the volume of the high-temperature chamber decreases and the volume of the low-temperature chamber increases correspondingly.

### CROSS-REFERENCE TO RELATED APPLICATIONS

The present application claims priority under 35 U.S.C. §119 to German Patent Application No. 10 2011 104 546.9 (filed on Jun. 18, 2011), which is hereby incorporated by reference in its respective entirety.

### FIELD OF THE INVENTION

The invention relates to a pump for conveying a cryogenic fluid, in particular cryogenic hydrogen, from a tank into a container which is under a higher pressure. The pump includes a cylinder with a piston which is arranged therein and which is configured to execute stroke movements running to and fro in the cylinder. The volume of a low-temperature chamber of the cylinder decreases during a first stroke movement of the piston which runs in one stroke direction. The volume of a high-temperature chamber, which lies in the cylinder on that side of the piston which is opposite the low-temperature chamber, increases correspondingly to the volume of the low-temperature chamber. Conversely, during a second stroke movement of the piston which runs in the opposite stroke direction, the volume of the high-temperature chamber decreases and the volume of the low-temperature chamber increases correspondingly.

The pump also includes a fluid inlet which issues into the low-temperature chamber and to which the tank is connected or connectable, a fluid outlet which leads out of the high-temperature chamber and to which the container is connected or connectable, and a fluid connection, via which the two chambers are connected to one another.

### BACKGROUND OF THE INVENTION

Conventional cryogenic pumps have a problem such that they only have relatively short operating periods in which they are maintenance-free. This applies particularly to conventional cryogenic piston pumps with small geometric dimensions (for example, piston diameters smaller than about 20 mm). For pumps of this type, the aim is to have an appreciably reduced outlay in maintenance terms, including a considerable lengthening of the maintenance-free operating periods, above all with regard to applications in motor vehicles.

### SUMMARY OF THE INVENTION

An object of the present invention is an enhanced pump which is also suitable particularly for use in motor vehicles.

The object and more are achieved in accordance with embodiments of the invention by a pump for conveying a cryogenic fluid, such as, for example, cryogenic hydrogen, from a tank into a container which is under a higher pressure. The pump includes a cylinder with a piston which is arranged therein and which can execute stroke movements running to and fro in the cylinder. The volume of a low temperature chamber of the cylinder decreases during a first stroke movement of the piston which runs in one stroke direction. The volume of a high temperature chamber of the cylinder, which lies on that side of the piston which is opposite the low temperature chamber, increases correspondingly. Conversely, during a second stroke movement of the piston which runs in the opposite stroke direction, the volume of the high temperature chamber decreases and the volume of the low temperature chamber increases correspondingly.

The pump also includes a fluid inlet which issues into the low temperature chamber and to which the tank is connected or connectable, a fluid outlet which leads out of the high temperature chamber and to which the container is connected or connectable, and a fluid connection, via which the two chambers are connected to one another. At least one heating device is designed for heating the fluid flowing, during the first stroke movement, out of the low temperature chamber through the fluid connection into the high temperature chamber, in such a way as to establish in the high temperature chamber a pressure which rises, in particular isochorically, with the temperature and which exceeds the container pressure.

In the pump in accordance with the invention, because the piston is arranged between the two chambers, the volume available for the fluid during the to-and-fro stroke movements of the piston remains constant. The at least approximately applicable state equation for ideal gases P*V/T=constant, P being the pressure, V the volume and T the temperature. Therefore this gives rise, in the case of a constant volume (V=constant), to a proportional relationship between the pressure P and the temperature T. State changes of this type are designated as isochoric state changes.

In the pump in accordance with the invention, the heating device causes an essentially isochoric state change in the fluid. In particular, the fluid flowing into the high-temperature chamber is heated greatly in such a way that the pressure of the fluid exceeds the container pressure, so that the fluid can flow via the fluid outlet out of the high-temperature chamber into the container until an equilibrium has been established between the pressure in the high-temperature chamber and the container pressure. As a result, therefore, the heating device causes not only heating of the fluid conveyed into the high-temperature chamber, but also a pressure rise, so that at least some of the fluid can flow into the container.

In the pump in accordance with the invention, therefore, it is possible, using a heating device, to pump fluid into a container which is under a higher pressure.

Since the heating device can be designed to be relatively robust and also compact, a reliable and slow-build pump can be implemented overall. By virtue of the compact form of construction, the pump not only requires a small stowage space, for example, in a motor vehicle, but also makes it possible that the pump in accordance with the invention can be heat-insulated with respect to the surroundings in a relatively simple way. Moreover, neither the piston/cylinder arrangement nor the heating device necessitate a high outlay in maintenance terms, so that, in the case of the pump, relatively long maintenance-free operating periods can also be achieved, for example, more than 2000 maintenance-free operating hours.

In accordance with the invention, the term “cryogenic fluid” or “fluid” is understood to mean a medium which has an extremely low temperature which, in particular, lies in the vicinity of the boiling point of the medium. For example, the cryogenic fluid may be cryogenic hydrogen, the boiling point of which is about 20 K. Moreover, the cryogenic fluid may be present in the pump, in the tank or in the container in the liquid phase and/or in the gaseous phase.

In accordance with an embodiment of the invention, at least one cooling device is designed for cooling the fluid which has remained in the high-temperature chamber and has not flowed out via the fluid outlet and which, during the second stroke movement, flows out of the high-temperature chamber via the fluid connection back into the low-temperature chamber, in such a way as to establish in the low-temperature chamber a pressure which decreases, in particular isochorically, with the temperature and which is lower than the tank pressure.

During the second stroke movement of the piston, therefore, the fluid which has remained in the high-temperature chamber is conveyed back into the low-temperature chamber again via the fluid connection, and at the same time being cooled and undergoing a simultaneous, essentially isochoric lowering of pressure. Since the low pressure is established in the low-temperature chamber, fluid can then flow out of the tank via the fluid inlet into the low-temperature chamber until the pressure in the low-temperature chamber has reached the tank pressure. Subsequently, the above-described first stroke movement of the piston can take place again, with the result that the fluid is pumped into the high-temperature chamber and further on into the container.

The arrangement of the cooling device, therefore, makes it possible to convey the fluid which has remained in the high-temperature chamber into the low-temperature chamber again, at the same time with a lowering of temperature and of pressure, in order to enable further fluid to replace it by flowing out of the tank into the low-temperature chamber. The cooling device can in this case, once again, have an especially robust and compact design, so that a compact and robust, maintenance-friendly pump can be implemented overall.

Preferably, the fluid connection is routed through the at least one heating device and/or the at least one cooling device, so that the heating device and/or the cooling device form/forms part of the fluid connection. Directed heating and/or directed cooling of the cryogenic fluid can thereby be achieved especially simply. Moreover, the pump can consequently be designed to be especially compact.

The at least one heating device may have a heat exchanger through which the fluid connection is routed. Since heat exchangers are very robust components, the maintenance-free operating period of the pump can be increased once again as a result of the use of a heat exchanger.

In this case, preferably, a primary branch of the heat exchanger forms part of the fluid connection. The primary branch is a line, which runs through the heat exchanger, for the fluid. Heat can be transmitted to the fluid flowing through the primary branch, for example by a heating device, especially an electrical heating device for the heat exchanger or by a medium flowing in a secondary branch of the heat exchanger. The secondary branch is a fluid line which is separate from the primary branch and which may be arranged, for example, in countercurrent, in co-current, in cross-current or in cross-countercurrent in relation to the primary branch.

Preferably, the heating device has a regenerator through which the fluid connection is routed, the regenerator also being provided as a cooling device for the fluid flowing, during the second stroke movement, out of the high-temperature chamber via the fluid connection back into the low-temperature chamber.

The regenerator may be considered as a heat transmitter which functions at the same time as a heat accumulator or cold accumulator. When the fluid flowing from the low-temperature chamber to the high-temperature chamber flows through the regenerator, the fluid is heated, for example, as a result of the cooling of an accumulator mass arranged in the regenerator. When the hotter fluid which has remained in the high-temperature chamber flows back into the low-temperature chamber again, it is cooled once more as a result of the heating of the accumulator mass. Overall, therefore, the regenerator forms a component of the pump according to the invention which serves both as a cooling device and as a heating device, so that a pump having an especially compact form of construction can be implemented. Moreover, the regenerator is essentially maintenance-free, so that even an especially robust pump with low maintenance requirements can be implemented.

The regenerator and the heat exchanger are especially preferably arranged in series along the fluid connection. Both components can thereby be integrated into the fluid connection especially simply.

Preferably, the regenerator is arranged upstream of the heat exchanger in the fluid connection, as seen from the low-temperature chamber. As a result, the regenerator functioning as a heat and cold accumulator is especially effective, since, during the first stroke movement of the piston, the cold fluid from the low-temperature chamber flows through this regenerator which is thus cooled essentially to the temperature of the cold fluid. Moreover, the regenerator can then cool to a greater extent the hotter fluid which, during the second stroke movement of the piston, flows out of the high-temperature chamber back into the low-temperature chamber again.

In accordance an embodiment of the invention, the fluid outlet has a one-way valve, through which the fluid can flow only in the outlet direction. It is thereby possible for the fluid to escape into the fluid outlet and consequently into the container when the pressure in the high-temperature chamber exceeds the container pressure. On the other hand, the fluid cannot flow out of the container into the high-temperature chamber.

Especially preferably, the fluid outlet is routed downstream of the one-way valve, as seen in the outlet direction, through a cooling device formed, in particular, by a or the heat exchanger. As a result, the fluid which has flowed through the one-way valve can be cooled, and therefore, where appropriate, its pressure, which may be higher than the container pressure, can be adapted to the container pressure.

In particular, part of the fluid outlet may be formed by a secondary branch of the heat exchanger, through the primary branch of which the fluid connection between the high-temperature chamber and the low-temperature chamber is routed. As a result, the fluid which flows in throttled expansion into the container can discharge heat to the cold fluid flowing through the primary branch during the first stroke movement. It thus becomes possible to heat the cold fluid, conveyed from the low-temperature chamber into the high-temperature chamber, by way of the fluid flowing via the fluid outlet into the container, while the fluid flowing into the container is cooled. The pump can consequently be operated especially effectively, and external, for example electrically operated, cold and/or heat sources do not have to be used or have to be used to only a slight extent.

Preferably, the fluid inlet has a valve, through which the fluid can flow in the inlet direction. The valve is, in particular, a one-way valve or a controllable valve, such as, for example, a solenoid valve, which can be activated by way of a valve control. What can thereby be achieved, on the one hand, is that fluid can flow out of the tank into the low-temperature chamber when the pressure in the low-temperature chamber lies below the tank pressure. On the other hand, the situation can be prevented where fluid escapes into the tank.

In accordance an embodiment of the invention, a mechanical or pneumatic or electromagnetic piston drive is provided for the piston. The piston drive is especially preferably decoupled mechanically from the piston, so that the piston can be decoupled thermally from the surroundings especially effectively.

Preferably, the piston is of at least partially magnetic design, the piston drive having two toroid coils. In this case, one toroid coil surrounds one end and the other toroid coil the other end of the cylinder. Furthermore, the piston drive has a control for the toroid coils which is designed for applying current to the toroid coils in such a way that magnetic fields are generated in the cylinder and drive the piston selectively in one stroke direction or the other. A simple piston drive decoupled mechanically from the piston can thereby be implemented, so that the cylinder/piston arrangement can be effectively insulated thermally with respect to the surroundings.

Preferably, the inlet and one end of the fluid connection issue into the base side of the low-temperature chamber, and the outlet and the other end of the fluid connection issue into the base side of the high-temperature chamber.

In accordance an embodiment of the invention, the pump is arranged inside the tank. The cryogenic pump can thereby be decoupled thermally from the surroundings in a simple way.

The pump in accordance with the invention is suitable especially for conveying a cryogenic fluid out of a low-pressure tank into a buffer store which is under higher pressure and which, for example, is part of a mixture-forming system of a drive assembly which uses the cryogenic fluid as fuel. A drive assembly of this type may be, for example, an internal combustion engine, a gas turbine or a jet engine.

One advantage of the pump in accordance with the invention is that it can not only be used for conveying the fuel in the direction of the drive assembly following the pump, but also for increasing the pressure of the cryogenic fluid. In this case, for example, the pressures of about 0.2 to 0.5 MPa required for internal combustion engines operating with external mixture formation can be achieved by way of the pump according to the invention. By way of the pump in accordance with the invention, pressures of about 1.0 to 2.0 MPa, required for an internal combustion engine which operates with an early start of injection at the commencement of the compression stroke in the case of what is known as internal mixture formation, can also be achieved. Moreover, the required pressures of about 10 to 20 MPa for internal combustion engines which operate with fuel injection with a late start of injection lying, for example, about 5° before the top dead centre can be achieved. The injection pressures for the combustion chambers of jet engines, which are necessary for jet engines in aviation or space travel and which lie in the range of about 3.0 to 5.0 MPa, can also be achieved by way of the pump in accordance with the invention.

The diameter of the piston of the pump may, for example, lie in the range of between 12 and 20 mm, so that, overall, a highly compact pump with a relatively low delivery rate of about 1 to 10 grams per second of liquid hydrogen can be implemented, which is especially suitable for use in motor vehicles with hydrogen drive, particularly in passenger cars, but also in heavy goods vehicles.

### BRIEF DESCRIPTION OF THE DRAWINGS

The invention is described below by means of exemplary embodiments illustrated in the drawing which shows:

FIG. 1 illustrates diagrammatically a block diagram of a fuel system.

### DETAILED DESCRIPTION OF EMBODIMENTS

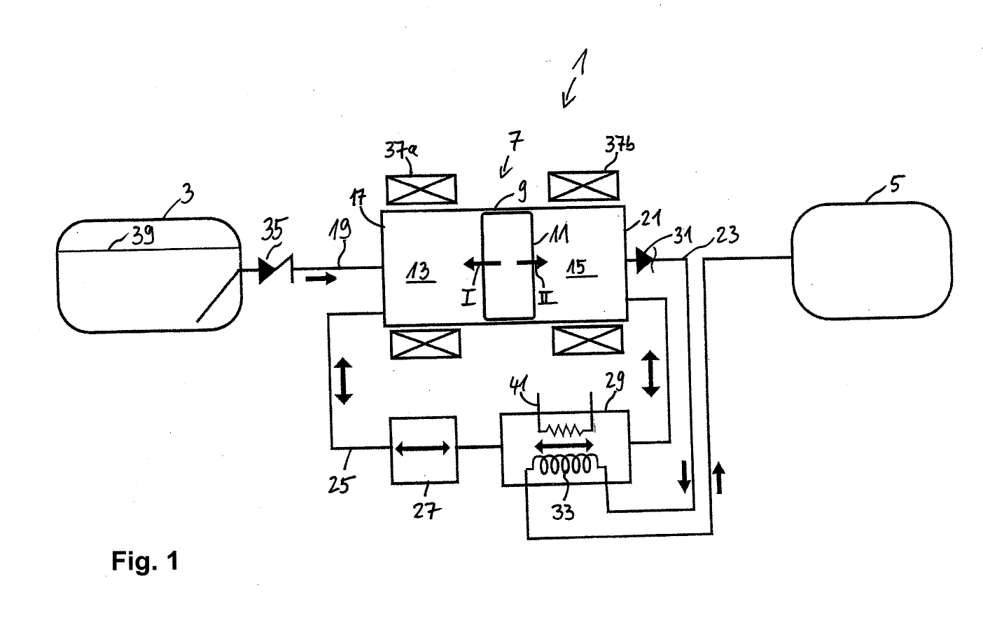

In FIG. 1, the fuel system 1 includes a low-pressure tank 3 having a volume sized to at least receive cryogenic hydrogen, a buffer store or container 5 for the cryogenic hydrogen and a pump 7 for conveying the cryogenic hydrogen from the tank 3 to the buffer store 5. The pump 7 has a cylinder 9 in which is arranged a piston 11 which can execute in the cylinder 9 stroke movements running to and fro in the direction of the longitudinal axis of the cylinder 9.

The piston 11 subdivides the cylinder interior into a low-temperature chamber 13 and a high-temperature chamber 15. As illustrated in FIG. 1, the volume of the low-temperature chamber 13 decreases during a first stroke movement of the piston 11 which runs in a first stroke direction I, whereas the volume of the high-temperature temperature 15 increases. Conversely, in the case of a second stroke movement of the piston 11 which runs in an opposite, second stroke direction II, the volume of the high-temperature chamber 15 decreases, whereas the volume of the low-temperature chamber 13 increases correspondingly, so that the overall volume of the low-temperature chamber 13 and of the high-temperature chamber 15 remains identical.

As illustrated in FIG. 1, a fluid inlet 19, to which the tank 3 is fluidically connected, issues into the base side 17, delimiting the low-temperature chamber 13, of the cylinder 9. Moreover, a fluid outlet 23, to which the container 5 is fluidically connected, is routed out of the base side 21, delimiting the high-temperature chamber 15 of the cylinder 9. Also, a fluid line 25 runs between the low-temperature chamber 13 and the high-temperature chamber 15, one end of the said fluid line issuing into the base side 17 and its other end issuing to the base side 21.

The fluid connection 25 is routed from the low-temperature chamber 13 through a regenerator 27 and then through a heat exchanger 29. In this case, the regenerator 27 and a primary branch (not illustrated) of the heat exchanger 29 form in each case a portion of the fluid connection 25. The fluid outlet 23 has a one-way valve 31 and runs downstream of the one-way valve 31, as seen in the outlet direction, through a secondary branch 33 of the heat exchanger 29, so that the secondary branch 33 forms a portion of the fluid outlet 23. The fluid outlet 23 issues into the buffer store 5 downstream of the secondary branch 33, as seen in the outlet direction.

The primary branch and the secondary branch 33 of the heat exchanger 29 are in each case fluid lines which are coupled thermally to one another, so that an exchange of heat energy between the fluid flowing in the secondary branch 33 and the fluid flowing in the primary branch can take place.

The fluid inlet 19 has a valve 35, through which the fluid can flow in the inlet direction, that is to say from the low-pressure tank 3 in the direction of the low-temperature chamber 13. The valve 35 may also be, in particular, a one-way valve or a solenoid valve activatable via a control (not shown).

In accordance with the invention illustrated, an electromagnetic drive is provided for the piston 11. The drive includes two toroid coils 37a, 37b, in each case one toroid coil 37a, 37b surrounding one end of the cylinder 9. The toroid coils 37a, 37b can be acted upon with electrical current by a control device (not illustrated) in such a way that they generate inside the cylinder 9 magnetic fields which drive the at least partially magnetically designed piston 11 selectively in the first stroke direction I or the second stroke direction II.

The low-pressure tank 3 is filled with cryogenic hydrogen up to a level 39 which is depicted by way of example. The temperature of the cryogenic hydrogen may amount, for example, to about 23 K. Moreover, the pressure in the low-pressure tank 3 may amount to about 0.2 MPa. By contrast, the pressure and also the temperature may be higher in the buffer store 5. For example, the temperature of the cryogenic hydrogen may amount there to about 35 K and the pressure to about 2 MPa.

The functioning of the pump 7 or of the fuel system 1 is described below by way of a pumping cycle. In this case, the piston 11 first executes a first stroke movement running in the first stroke direction I. The piston 11 moves from the base side 21 towards the base side 17, so that the volume of the high-temperature chamber 15 increases and the volume of the low-temperature chamber 13 decreases correspondingly. The cryogenic hydrogen contained in the low-temperature chamber 13 is in this case pressed through the fluid connection 25 into the high-temperature chamber 15. In this case, the cold hydrogen is heated in the regenerator 27, the regenerator 27 at the same time being cooled. Moreover, the hydrogen in the primary branch of the heat exchanger 29 is heated to a temperature TW lying above the temperature of the buffer store 5.

For this purpose, the heat exchanger 29 includes electrical heating 41 which, for example, includes a heating spiral which is wound around the primary branch. Moreover, heating of the hydrogen flowing through the primary branch takes place by way of the secondary branch 33. The heating of the cryogenic hydrogen results in an, in particular isochoric, pressure rise of the fluid in the high-temperature chamber 15, while, after the pressure level of the buffer store 5 is reached, the hydrogen can flow via the valve 31 in throttled expansion via the fluid outlet 23 and the secondary branch 33 into the buffer store 5.

During the second stroke movement of the piston 11 which runs in the opposite, second stroke direction II, the piston 11 moves from the base side 17 towards the base side 21. In this case, the volume of the low-temperature chamber 13 increases, while that of the high-temperature chamber 15 decreases. The hydrogen which has remained in the high-temperature chamber 15 flows via the fluid connection 25 and consequently through the primary branch of the heat exchanger 29, no heat being absorbed or discharged since, because of the first stroke movement, the heat exchanger 29 has essentially the same temperature TW as the fluid flowing back from the high-temperature chamber 15. The fluid subsequently flows through the regenerator 27 which is cold from the preceding piston phase, so that the hydrogen is cooled by the regenerator 27. The pressure in the low-temperature chamber 13 consequently falls below the tank pressure, so that further hydrogen can flow out of the tank 3 into the low-temperature chamber 13. As soon as the piston 11 has reached the base side 21, the pumping cycle ends, and a new cycle for conveying the hydrogen from the low-pressure tank 3 to the buffer store 5 can commence in accordance with the above description.

In the embodiment described, it is advantageous that the series arrangement of the regenerator 27 and of the heat exchanger 29 in the fluid connection 25 causes on the one hand isochoric heating, along with a corresponding pressure build-up, of the cryogenic hydrogen conveyed from the low-temperature chamber 13 into the high-temperature chamber 15. The rest of the cryogenic hydrogen which has remained in the high-temperature chamber 15 and which has not flowed through the valve 31 into the buffer store 5 is regeneratively cooled in the regenerator 27, along with a decreasing pressure, and is subsequently heated by the hydrogen flowing to replace it out of the low-pressure tank 3 and is brought to the temperature TW again in the heat exchanger 29, using the heat released during the isenthalpic throttling of the, in particular super critical, hydrogen flowing into the buffer store 5.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A pump comprising:
a cylinder having a piston which defines a low-temperature chamber and a high-temperature chamber in the cylinder such that during a first stroke movement of the piston, the volume of the low-temperature chamber decreases and the volume of the high-temperature chamber increases correspondingly, and during a second stroke movement of the piston which runs in the opposite direction of the first stroke movement, the volume of the high-temperature chamber decreases and the volume of the low-temperature chamber increases correspondingly;
a fluid inlet at the low-temperature chamber;
a fluid outlet at the high-temperature chamber;
a fluid line which fluidically connects the low-temperature chamber and the high-temperature chamber to one another; and
at least one heating device which heats a fluid which flows during the first stroke movement, from the low-temperature chamber through the fluid line and to the high-temperature chamber, so as to establish in the high-temperature chamber a pressure rises isochorically, with the temperature in the high-temperature chamber.

2. The pump of claim 1, wherein the at least one heating device has a heat exchanger through which the fluid connection is routed.

3. The pump of claim 2, wherein the at least one heating device has a regenerator through which the fluid line is routed, the regenerator serving as a cooling device for the fluid flowing, during the second stroke movement, from the high-temperature chamber via the fluid line back into the low-temperature chamber.

4. The pump of claim 3, wherein the regenerator and the heat exchanger are arranged in series in the fluid connection, the regenerator being arranged upstream of the heat exchanger in the fluid line.

5. A pump for conveying a cryogenic fluid from a first fluid vessel into a second fluid vessel which is under a higher pressure than the first fluid vessel, the pump comprising:
a cylinder having a piston which defines a low-temperature chamber and a high-temperature chamber in the cylinder such that during a first stroke movement of the piston, the volume of the low-temperature chamber decreases and the volume of the high-temperature chamber increases correspondingly, and during a second stroke movement of the piston which runs in the opposite direction of the first stroke movement, the volume of the high-temperature chamber decreases and the volume of the low-temperature chamber increases correspondingly;
a fluid inlet at the low-temperature chamber and which is fluidically connected to the first fluid vessel;
a fluid outlet at the high-temperature chamber and which is fluidically connected to the second fluid vessel;
a fluid line which fluidically connects the low-temperature chamber and the high-temperature chamber to one another; and
at least one heating device which heats the cryogenic fluid which flows during the first stroke movement, from the low-temperature chamber through the fluid line and to the high-temperature chamber, so as to establish in the high-temperature chamber a pressure rises isochorically with the temperature in the high-temperature chamber and which exceeds the pressure in the second fluid vessel.

6. The pump of claim 5, further comprising at least one cooling device which cools the cryogenic fluid which remains in the high-temperature chamber and which has not flowed from the high-temperature chamber via the fluid outlet and which, during the second stroke movement, flows from the high-temperature chamber via the fluid line back into the low-temperature chamber, in such a way as to establish in the low-temperature chamber a pressure which decreases isochorically with the temperature in the low-temperature chamber and which is lower than the pressure in the first fluid vessel.

7. The pump of claim 6, wherein the fluid line is routed through the at least one of the at least heating device and the at least one cooling device.

8. The pump of claim 5, wherein the at least one heating device has a heat exchanger through which the fluid line is routed, a primary branch of the heat exchanger forming a portion of the fluid line.

9. The pump of claim 5, wherein the at least one heating device has a regenerator through which the fluid line is routed, the regenerator serving as a cooling device for the cryogenic fluid which flows during the second stroke movement, out of the high-temperature chamber via the fluid line back into the low-temperature chamber.

10. The pump of claim 9, wherein the regenerator and the heat exchanger are arranged in series in the fluid connection.

11. The pump of claim 5, wherein the fluid outlet has a first valve through which the cryogenic fluid flows.

12. The pump of claim 11, wherein the first valve comprises a one-way valve.

13. The pump of claim 5, wherein the fluid inlet has a second valve, through which the cryogenic fluid flows.

14. The pump of claim 13, wherein the second valve comprises a one-way valve.

15. The pump of claim 5, further comprising a piston drive which is decoupled mechanically from the piston.

16. The pump of claim 15, wherein the piston drive comprises one of a mechanical piston drive, a pneumatic piston drive and an electromagnetic piston drive.

17. The pump of claim 16, wherein:
the piston is of at least a partially magnetic structure, including a first toroid coil surrounding a first end of the pump and a second toroid coil surrounding a second end of the cylinder; and
the piston drive has a control for the first toroid coil and the second toroid coil and which is configured to apply current to the first toroid coil and the second toroid coil in such a way that magnetic fields are generated in the cylinder and drive the piston selectively in the first stroke direction and the second stroke direction.

18. The pump of claim 5, wherein the pump is arranged inside the first fluid vessel.

19. A fuel system comprising:
a first fluid vessel;
a second fluid vessel which is under a higher pressure than the first fluid vessel; and
a pump which conveys a fluid from the first fluid vessel into the second fluid vessel, the pump including a cylinder having a piston which defines a low-temperature chamber and a high-temperature chamber in the cylinder such that during a first stroke movement of the piston, the volume of the low-temperature chamber decreases and the volume of the high-temperature chamber increases correspondingly, and during a second stroke movement of the piston which runs in the opposite direction of the first stroke movement, the volume of the high-temperature chamber decreases and the volume of the low-temperature chamber increases correspondingly, a fluid line which fluidically connects the low-temperature chamber and the high-temperature chamber to one another, and at least one heating device which heats the cryogenic fluid which flows during the first stroke movement, from the low-temperature chamber through the fluid line and to the high-temperature chamber, so as to establish in the high-temperature chamber a pressure rises isochorically with the temperature in the high-temperature chamber and which exceeds the pressure in the second fluid vessel.

20. The fuel system of claim 19, wherein the fluid comprises a cryogenic fluid.
